(19) United States
(12) Patent Application Publication
(10) Pub. No.: US 2012/0113362 A1
(43) Pub. Date: May 10, 2012

(54) LIQUID CRYSTAL DISPLAY

(76) Inventors: Jae-Ik Lim, Yongin-city (KR); Jae-Hyun Kim, Yongin-city (KR); Jong-In Beak, Yongin-city (KR)

(21) Appl. No.: 13/076,307

(22) Filed: Mar. 30, 2011

(30) Foreign Application Priority Data
Nov. 8, 2010 (KR) 10-2010-0110576

(51) Int. Cl. G02F 1/1335; G02F 1/1343

(52) U.S. Cl. 349/96; 349/139

(57) ABSTRACT

A liquid crystal display panel includes a liquid crystal display panel for displaying an image, and a viewing angle adjustment layer on the liquid crystal display panel. The viewing angle adjustment layer includes: a lower cutoff polarizing plate; a lower cutoff electrode on the lower cutoff polarizing plate; an upper cutoff polarizing plate facing the lower cutoff polarizing plate; an upper cutoff electrode on the upper cutoff polarizing plate; and a liquid crystal capsule layer between the lower cutoff electrode and the upper cutoff electrode. The liquid crystal capsule layer includes a plurality of liquid crystal capsules. A diameter of the liquid crystal capsules is between 50 nm and a shortest wavelength of visible light.

### CROSS-REFERENCE TO RELATED APPLICATION

This application claims priority to and the benefit of Korean Patent Application No. 10-2010-0110576 filed in the Korean Intellectual Property Office on Nov. 8, 2010, the entire content of which is incorporated herein by reference.

### BACKGROUND

1. Field

Aspects of embodiments according to the present invention relate generally to a liquid crystal display.

2. Description of Related Art

Liquid crystal displays are now one of the most widely used flat panel displays. An exemplary liquid crystal display may be composed of two substrates having electrodes and a liquid crystal layer inserted between the substrates. Such a liquid crystal display may adjust the amount of transmissive light by rearranging the liquid crystal molecules in the liquid crystal layer, using voltage applied to the electrodes.

A wide viewing angle, that is, the ability to view a display at various angles, is an important characteristic in liquid crystal displays. Liquid crystal displays should provide image quality that is clear and not distorted even in a wide viewing angle range. Accordingly, technologies of implementing a wide viewing angle have been developed.

However, there are also circumstances where a narrow viewing angle mode is required, such as when working with secret or confidential documents. Under these circumstances, the liquid crystal display may be more secure if only a person right in front of the display is able to see the image on the display.

For this purpose, a structure with a viewing angle adjustment layer of a HAN (hybrid aligned nematic) mode has been proposed. In such a display, a wide viewing angle characteristic is implemented when voltage is applied to the viewing angle adjustment layer. This may result, however, in increased power consumption. In addition, a negative C plate has been proposed to implement the wide viewing angle characteristic, in which case the viewing angle adjustment layer is a liquid crystal layer located between glass substrates. This may result, however, in the thickness of the liquid crystal display being increased by the additional glass substrate.

Further, a structure with a viewing angle adjustment layer of an ECB (electrically controlled birefringence) mode having a plurality of domains has been proposed. However, it is not easy to rub the domains. In addition, as with the negative C plate, the viewing angle adjustment layer is a liquid crystal layer located between glass substrates, in which case the thickness of the liquid crystal display is increased by the additional glass substrate.

Finally, a structure with a viewing angle adjustment layer of an ECB mode where a liquid crystal has a linear inclination in one domain has been proposed. However, yellow coloration may take place in the vertical direction and side luminance may decrease.

The above information disclosed in this Background section is only for enhancement of understanding of the background of aspects of the invention and therefore it may contain information that does not form the prior art that is already known in this country to a person of ordinary skill in the art.

### SUMMARY

Aspects of embodiments according to the present invention provide for a liquid crystal display capable of adjusting a viewing angle.

In an exemplary embodiment according to the present invention, a liquid crystal display is provided. The liquid crystal display includes a liquid crystal display panel for displaying an image, and a viewing angle adjustment layer on the liquid crystal display panel. The viewing angle adjustment layer includes a lower cutoff polarizing plate, a lower cutoff electrode on the lower cutoff polarizing plate, an upper cutoff polarizing plate facing the lower cutoff polarizing plate, an upper cutoff electrode on the upper cutoff polarizing plate, and a liquid crystal capsule layer between the lower cutoff electrode and the upper cutoff electrode. The liquid crystal capsule layer includes a plurality of liquid crystal capsules. A diameter of the liquid crystal capsules is between 50 nm and a shortest wavelength of visible light.

A transmissive axis of the lower cutoff polarizing plate and a transmissive axis of the upper cutoff polarizing plate may be parallel to each other.

The upper cutoff electrode may have a plurality of horizontal cut-off portions parallel to a transmissive axis of the lower cutoff polarizing plate.

The upper cutoff electrode may have a plurality of vertical cut-off portions perpendicular to a transmissive axis of the lower cutoff polarizing plate.

The lower cutoff electrode may have a plurality of horizontal cut-off portions parallel to a transmissive axis of the lower cutoff polarizing plate.

The lower cutoff electrode may have a plurality of vertical cut-off portions perpendicular to a transmissive axis of the lower cutoff polarizing plate.

In another exemplary embodiment according to the present invention, a liquid crystal display is provided. The liquid crystal display includes a liquid crystal display panel for displaying an image, and a viewing angle adjustment layer on the liquid crystal display panel. The viewing angle adjustment layer includes a common cutoff electrode on the liquid crystal display panel, a pixel cutoff electrode on the liquid crystal display panel and parallel to the common cutoff electrode, an upper cutoff substrate having an inner side facing the liquid crystal display panel, and a liquid crystal capsule layer between the common cutoff electrode, the pixel cutoff electrode, and the upper cutoff substrate. The liquid crystal capsule layer includes a plurality of liquid crystal capsules. A diameter of the liquid crystal capsules is between 50 nm and a shortest wavelength of visible light.

The liquid crystal display may further include a lower display polarizing plate at a bottom of the liquid crystal display panel, and an upper display polarizing plate at an outer side of the upper cutoff substrate.

The common cutoff electrode may have a long side that makes an angle with a transmissive axis of the lower display polarizing plate of 45 degrees±10 degrees.

In yet another exemplary embodiment according to the present invention, a liquid crystal display is provided. The liquid crystal display includes a liquid crystal display panel for displaying an image, and a viewing angle adjustment layer on the liquid crystal display panel. The viewing angle adjustment layer includes an upper cutoff substrate having an inner side facing the liquid crystal display panel, a common cutoff electrode on the upper cutoff substrate, a pixel cutoff electrode on the upper cutoff substrate and parallel to the common cutoff electrode, and a liquid crystal capsule layer between the liquid crystal display panel, the common cutoff electrode, and the pixel cutoff electrode. The liquid crystal capsule layer includes a plurality of liquid crystal capsules. A diameter of the liquid crystal capsules is between 50 nm and a shortest wavelength of visible light.

The liquid crystal display may further include a lower display polarizing plate at a bottom of the liquid crystal display panel, and an upper display polarizing plate at an outer side of the upper cutoff substrate.

The common cutoff electrode may have a long side that makes an angle with a transmissive axis of the lower display polarizing plate of 45 degrees±10 degrees.

According to exemplary embodiments, it is possible to satisfy both the wide viewing angle characteristic and the narrow viewing angle characteristic by forming a viewing angle adjustment layer having a liquid crystal capsule layer including liquid crystal capsules having a diameter between 50 nanometers (nm) and the shortest wavelength of visible light. Further, since the liquid crystal capsule layer is attached like a film on the lower cutoff electrode formed on the lower cutoff polarizing plate or directly coated on the lower cutoff electrode by deposition, in the viewing angle adjustment layer, it is possible to reduce the thickness of the liquid crystal display when compared to solutions that involve adding glass substrates and injecting liquid crystals between the glass substrates.

### BRIEF DESCRIPTION OF THE DRAWINGS

FIG. 1 is an exploded perspective view illustrating when a cutoff voltage is not being applied to a viewing angle adjustment layer of a liquid crystal display according to a first exemplary embodiment.

FIG. 2 is a cross-sectional view illustrating when a cutoff voltage is not being applied to the viewing angle adjustment layer of the liquid crystal display according to the first exemplary embodiment.

FIG. 3 is a graph showing a contrast ratio of the viewing angle adjustment layer in accordance with the diameter of a liquid crystal capsule in the liquid crystal display according to the first exemplary embodiment.

FIG. 4 is an exploded perspective view illustrated when a cutoff voltage is being applied to the viewing angle adjustment layer of the liquid crystal display according to the first exemplary embodiment.

FIG. 5 is a cross-sectional view illustrating when a cutoff voltage is being applied to the viewing angle adjustment layer of the liquid crystal display according to the first exemplary embodiment.

FIG. 6 is a view showing polarization of light passing through the liquid crystal display of FIGS. 4 and 5, when voltage is being applied to the viewing angle adjustment layer.

FIG. 7 is a graph showing luminance according to the viewing angle adjustment layer, when a cutoff voltage is being applied and not being applied to the viewing angle adjustment layer of the liquid crystal display according to the first exemplary embodiment.

FIG. 8 is an exploded perspective view illustrating when a cutoff voltage is being applied to a viewing angle adjustment layer of a liquid crystal display according to a second exemplary embodiment.

FIG. 9 is an exploded perspective view illustrating when a cutoff voltage is being applied to a viewing angle adjustment layer of a liquid crystal display according to a third exemplary embodiment.

FIG. 10 is an exploded perspective view illustrating when a cutoff voltage is being applied to a viewing angle adjustment layer of a liquid crystal display according to a fourth exemplary embodiment.

FIG. 11 is an exploded perspective view illustrating when a cutoff voltage is not being applied to a viewing angle adjustment layer of a liquid crystal display according to a fifth exemplary embodiment.

FIG. 12 is an exploded perspective view illustrating when a cutoff voltage is being applied to the viewing angle adjustment layer of the liquid crystal display according to the fifth exemplary embodiment.

FIG. 13 is an exploded perspective view illustrating when a cutoff voltage is not being applied to a viewing angle adjustment layer of a liquid crystal display according to a sixth exemplary embodiment.

FIG. 14 is an exploded perspective view illustrating when a cutoff voltage is being applied to the viewing angle adjustment layer of the liquid crystal display according to the sixth exemplary embodiment.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification. Further, the sizes and thicknesses of the components shown in the drawings are for better understanding and ease of description of the embodiments. The present invention is not limited to the examples shown in the drawings.

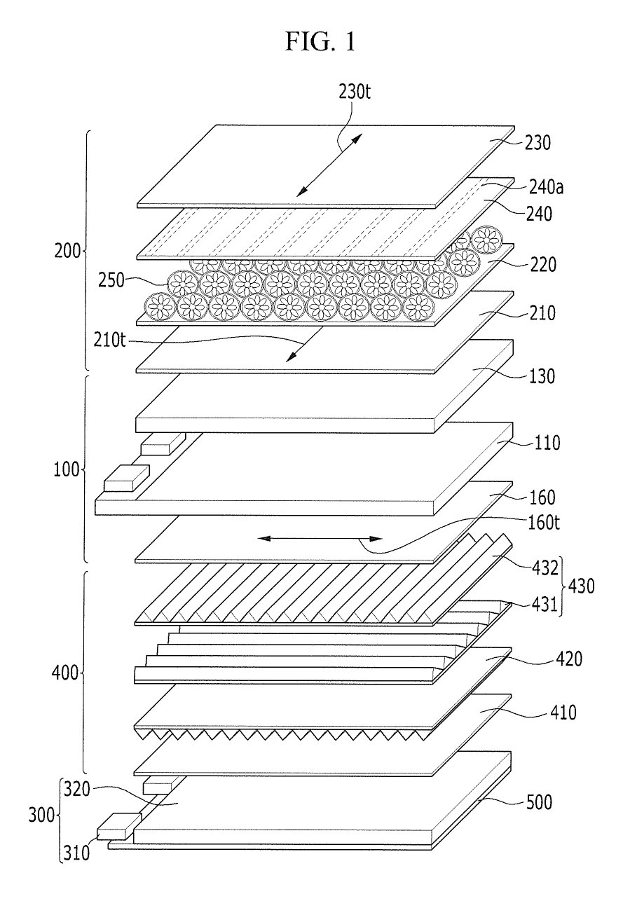

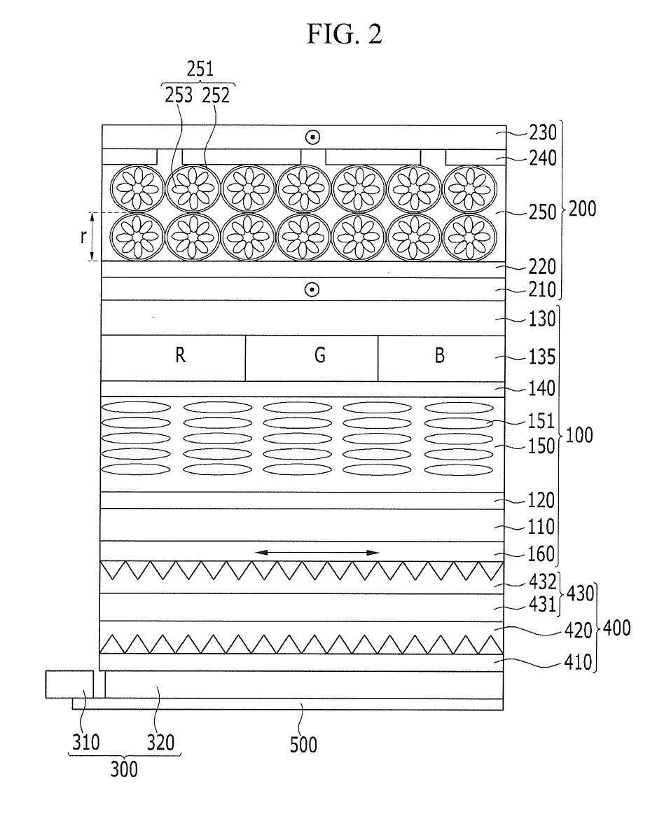

Hereinafter, a liquid crystal display according to a first exemplary embodiment is described in detail with reference to FIGS. 1 and 2.

FIG. 1 is an exploded perspective view illustrating when a cutoff voltage is not being applied to a viewing angle adjustment layer 200 of the liquid crystal display. FIG. 2 is a cross-sectional view illustrating when a cutoff voltage is not being applied to the viewing angle adjustment layer 200 of the liquid crystal display. As shown in FIG. 1 and in FIG. 2, the liquid crystal display includes a liquid crystal display panel 100 displaying an image and a viewing angle adjustment layer 200 formed on the liquid crystal display panel 100.

The liquid crystal display panel 100 includes a lower display substrate 110, a pixel electrode 120 formed on the lower display substrate 110, an upper display substrate 130 facing the lower display substrate 110, a color filter 135 formed on the upper display substrate 130, a common electrode 140 formed on the color filter 135, and a liquid crystal layer 150 formed between the pixel electrode 120 and the common electrode 140. A lower display polarizing plate 160 is located under the lower display substrate 110 of the liquid crystal display panel 100.

The lower display substrate 110 and the upper display substrate 130 are insulation substrates made of transparent glass or plastic. The pixel electrode 120 and the common electrode 140 are made of transparent ITO or IZO. A vertical electric field is generated between the pixel electrode 120 and the common electrode 140 that face each other when driving voltage is applied.

The liquid crystal layer 150 may be any one selected from an electrically controlled birefringence (ECB) mode, a twisted nematic (TN) mode, or a vertical alignment (VA) mode. The liquid crystal layer 150 is described for the ECB mode in the first exemplary embodiment. The ECB mode is a liquid crystal mode where liquid crystal molecules 151 of the liquid crystal layer 150 are arranged in parallel, close to be horizontal, between the lower display substrate 110 and the upper display substrate 130 when driving voltage is not applied. See, for example, the orientation of the liquid crystal molecules 151 in the liquid crystal display in FIG. 2. On the other hand, when the driving voltage is applied, the liquid crystal molecules 151 are arranged at an angle, close to vertical, thereby adjusting the transmissive amount of light.

The liquid crystal layer 150 of each of the ECB mode, the TN mode, and the VA mode forms a vertical electric field between the upper display substrate 130 and the lower display substrate 110. In other embodiments, the liquid crystal layer 150 may be an in-plane switching (IPS) mode or a fringe field switching (FFS) mode that forms a horizontal electric field between the common electrode 140 and the pixel electrode 120, which are both formed on the lower display substrate 110.

The viewing angle adjustment layer 200 includes a lower cutoff polarizing plate 210, a lower cutoff electrode 220 formed on the lower cutoff polarizing plate 210, an upper cutoff polarizing plate 230 facing the lower cutoff polarizing plate 210, an upper cutoff electrode 240 formed on the upper cutoff polarizing plate 230, and a liquid crystal capsule layer 250 located between the lower cutoff electrode 220 and the upper cutoff electrode 240 and including a plurality of liquid crystal capsules 251.

The plurality of liquid crystal capsules 251 have a substantially uniform size and are distributed on the liquid crystal capsule layer 250. Each of the liquid crystal capsules 251 includes a plurality of liquid crystal molecules 253 disposed inside a capsule outer layer 252. The capsule outer layer 252 may be made of a natural polymer such as gelatin, Arabic gum, or sodium alginate; a semi-synthetic polymer such as carboxymethyl, cellulose, or ethyl cellulose; or a synthetic polymer such as polyvinyl alcohol, nylon, polyurethane, polyester, epoxy, or melamine-formalin.

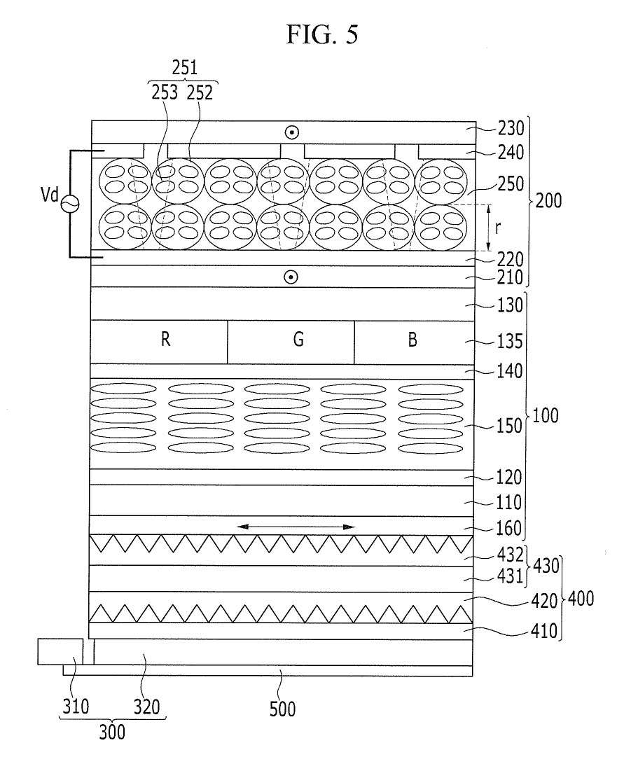

The liquid crystal capsule 251 can be manufactured by equipment, such as a microfluidizer or an ultrasonic wave microfluidizer and a diameter r (see FIG. 5) of the liquid crystal capsule 251 is between 50 nm and the shortest wavelength of visible light. The visible light wavelengths range from about 380 nm to 780 nm. The diameters r of the liquid crystal capsules 251 are nearly uniform, within a difference of no more than ±6.5%.

When the diameter r of the liquid crystal capsule 251 is larger than the shortest visible light wavelength, light may be scattered by the liquid crystal capsule 251 and the liquid crystal capsule 251 may become opaque, such that the contrast ratio of the viewing angle adjustment layer 200 decreases. The thickness of the capsule outer layer 252 is 1 nm to 10 nm; therefore, the diameter of the liquid crystal capsule 251 should not be smaller than 50 nm.

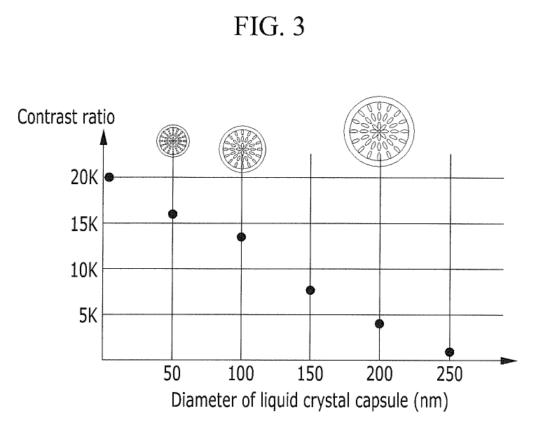

FIG. 3 is a graph showing a contrast ratio of the viewing angle adjustment layer 200 in accordance with the diameter of a liquid crystal capsule 251 in the liquid crystal display according to the first exemplary embodiment. FIG. 3 shows measurements when the refractive index between the liquid crystal molecules 253 and the capsule outer layer 252 is 3% or less. In addition, for comparison purposes, the point corresponding to 0 nm diameter (that is, no liquid crystal capsules 251) and 20,000 contrast ratio has been added to show the 20,000 contrast ratio that is exhibited when the liquid crystal capsule layer 250 is replaced with bare glass.

As shown in FIG. 3, it can be seen that the smaller the diameter r of the liquid crystal capsule 251, the larger the contrast ratio of the viewing angle adjustment layer 200. That is, since the liquid crystal molecules 253 in the liquid crystal capsule 251 are randomly arranged and the diameter r of the liquid crystal capsule 251 is smaller than the shortest visible light wavelength, light is not scattered by the liquid crystal capsule 251. Therefore, the liquid crystal capsule 251 appears transparent and the contrast ratio of the viewing angle adjustment layer 200 increases. As shown in FIG. 3, the largest contrast ratio is about 16,000 (compared to the 20,000 contrast ratio of bare glass) when the diameter r of the liquid crystal capsule 251 is 50 nm, and the contrast ratio gets progressively smaller as the diameter r of the liquid crystal capsule 251 increases. Thus, it can be seen that the contrast ratio of the viewing angle adjustment layer 200 is improved with a smaller diameter r of the liquid crystal capsule 251.

The liquid crystal capsule layer 250 may be formed by mixing a plurality of liquid crystal capsules 251 with a binder, an additive, and a solvent and roll-to-roll coating, inkjet-coating, screen-coating, spin-coating, or slit-coating the mixture. The thickness of the liquid crystal capsule layer 250 may be several μm to tens of μm.

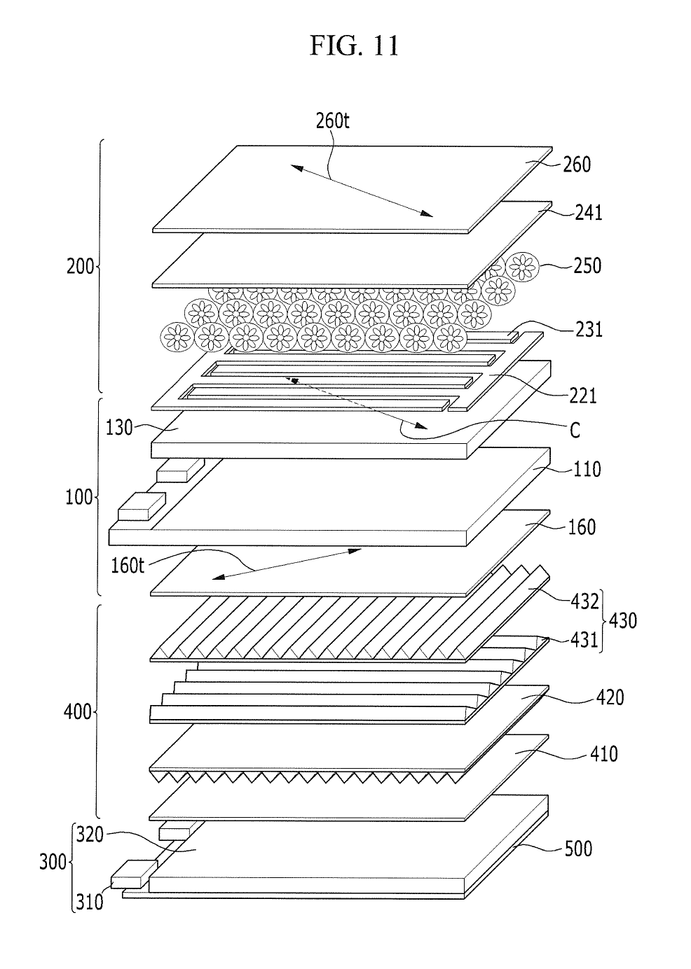

The lower cutoff electrode 220 may be attached like a film on the lower cutoff polarizing plate 210 or directly formed on the lower cutoff polarizing plate 210 by deposition. The upper cutoff electrode 240 may also be attached like a film on the upper cutoff polarizing plate 230 or directly formed on the upper cutoff polarizing plate 230 by deposition. Further, a specific upper cutoff substrate (see upper cutoff substrate 241 in FIGS. 11 through 14) may be located between the upper cutoff electrode 240 and the upper cutoff polarizing plate 230 to prevent the liquid crystal capsule layer 250 from being deformed by external pressure. The upper cutoff substrate may be, for example, an insulation substrate made of transparent glass or plastic.

A transmissive axis 210t of the lower cutoff polarizing plate 210 and a transmissive axis 230t of the upper cutoff polarizing plate 230 are parallel to each other (i.e., coplanar). Further, the upper cutoff electrode 240 has a plurality of horizontal cut-off portions 240a that are parallel to the transmissive axis of the lower cutoff polarizing plate 210.

As described above, the viewing angle adjustment layer 200 does not have a structure in which liquid crystals are injected between glass substrates. This is because the liquid crystal capsule layer 250 is attached as a film on the lower cutoff electrode 220 formed on the lower cutoff polarizing plate 210 or directly coated on the lower cutoff electrode 220 by deposition, such that a specific glass substrate is not needed. Therefore, it is possible to reduce the thickness of the liquid crystal display when compared to alternative designs.

Further, the viewing angle adjustment layer 200 does not significantly influence the image quality of the liquid crystal display panel 100. That is, the liquid crystal molecules 253 in the liquid crystal capsule 251 are randomly arranged when a cutoff voltage Vd is not applied and have an isotropy, such that a phase delay does not occur when viewing from the sides. Therefore, color shift or reduction of luminance according to the viewing angle does not appear to take place and the image quality of the liquid crystal display panel 100 is not significantly influenced.

A transmissive axis 160t of the lower display polarizing plate 160 of the liquid crystal display panel 100 is perpendicular to (and thus, not coplanar with) the transmissive axis 210t of the lower cutoff polarizing plate 210. A backlight unit 300 supplying light to the liquid crystal display panel 100 and an optical film unit 400 located between the liquid crystal display panel 100 and the backlight unit 300 are located under the lower display polarizing plate 160. The optical film unit is for making the luminance of the light generated from the backlight unit 300 more uniform.

The backlight unit 300 has a plurality of light sources 310 generating light and a light guide panel 320 guiding the light from the light sources 310 to the liquid crystal display panel 100. The light sources 310 are located around the edge of the light guide panel 320. The light guide panel 320 has a size corresponding to the liquid crystal display panel 100. The optical film unit 400 is located on the light guide panel 320. The optical film unit 400 is for making light appear more uniform as it travels from the light guide panel 320 to the liquid crystal display panel 100. A reflective plate 500 is located under the backlight unit 300. The reflective plate 500 is for improving light efficiency by reflecting light coming from the light guide panel 320 back to the light guide panel 320.

The optical film unit 400 is composed of a plurality of optical films, including a diffusion film 410, a reverse prism film 420, and a brightness enhancement film (BEF) 430. The diffusion film 410 makes luminance distribution more uniform by diffusing light generated from the backlight unit 300. The reverse prism film 420 collects the light having more uniform luminance distribution from the diffusion film 410 and makes the light travel to the front (that is, in the direction of the liquid crystal display panel 100). The brightness enhancement film (BEF) 430 improves the luminance by transmitting the P-wave and recycling the S-wave of the light source. The brightness enhancement film includes a vertical brightness enhancement film 431 and a horizontal brightness enhancement film 432. The reverse prism film 420 is disposed on the diffusion film 410 and the brightness enhancement film 430 is disposed on the reverse prism film 420.

As described above, the liquid crystal display having the viewing angle adjustment layer 200 can freely distort the display information of the liquid crystal display panel 100 in the side direction, without distorting the display information of the liquid crystal display panel 100 in the front direction.

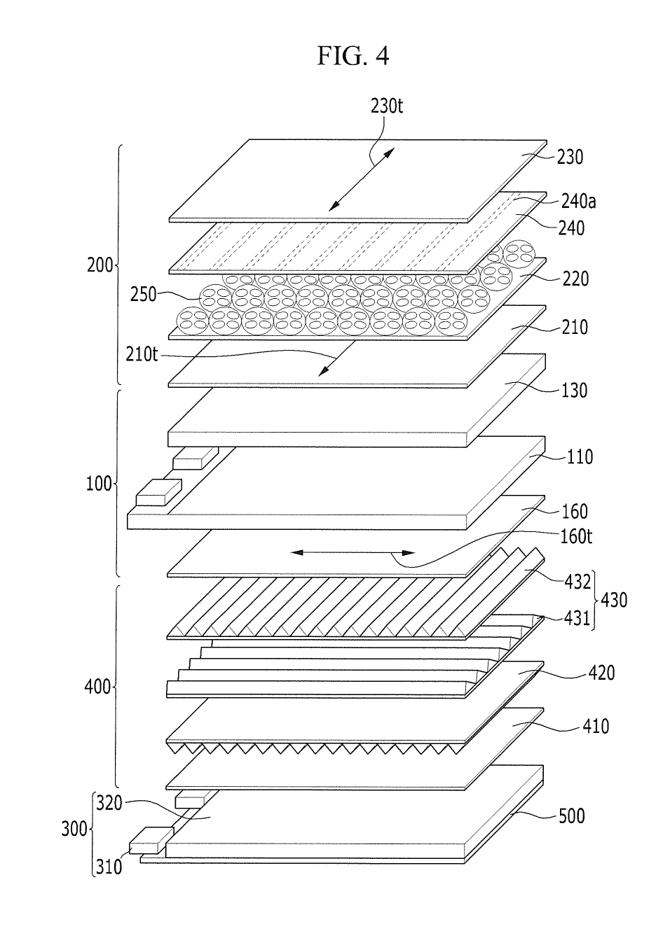

The operation of the liquid crystal display according to the first exemplary embodiment is further described in detail with reference to FIGS. 4 and 5.

FIG. 4 is an exploded perspective view illustrating when a cutoff voltage is being applied to the viewing angle adjustment layer 200 of the liquid crystal display. FIG. 5 is a cross-sectional view illustrating when a cutoff voltage is being applied to the viewing angle adjustment layer 200 of the liquid crystal display.

As shown in FIGS. 4 and 5, when a cutoff voltage Vd is applied to the viewing angle adjustment layer 200 of the liquid crystal display, a vertical electric field is generated between the lower cutoff electrode 220 and the upper cutoff electrode 240. The liquid crystal molecules 253 in the liquid crystal capsule 251 are arranged perpendicular to the vertical electric field, because they have negative dielectric anisotropy. The vertical electric field bends around the horizontal cut-off portions 240a of the upper cutoff electrode 240. The liquid crystal molecules arrange themselves accordingly, to still stay perpendicular to the electric field, such that the liquid crystal molecules 253 in the liquid crystal capsule 251 are arranged at angles (for example, predetermined angles) with respect to the horizontal surface of the upper cutoff electrode 240. The liquid crystal molecules 253 are arranged at angles that oppose each other with respect to the horizontal cut-off portions 240a of the upper cutoff electrode 240 (depending on whether the liquid crystal molecules 253 are aligning with the electric field bending around one side of a horizontal cut-off portion 240a or around the other side).

The horizontal cut-off portion 240a of the upper cutoff electrode 240 is parallel to the transmissive axis 210t of the lower cutoff polarizing plate 210 while the transmissive axis 210t of the lower cutoff polarizing plate 210 and the transmissive axis 230t of the upper cutoff polarizing plate 230 are parallel to each other.

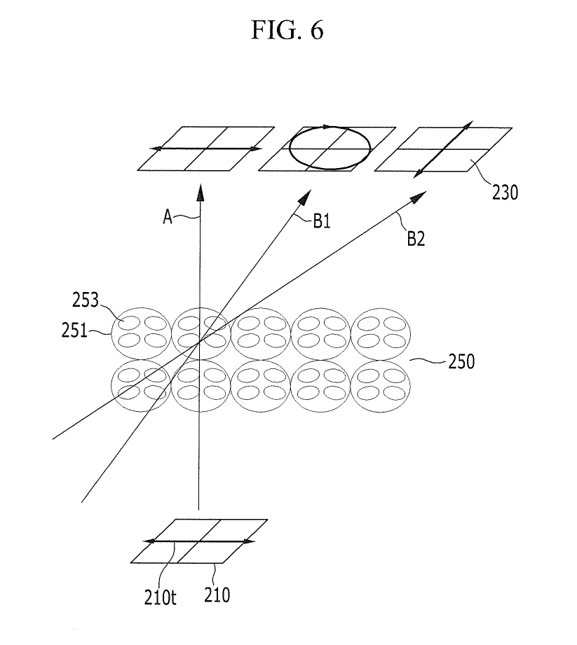

The polarized state of the light passing through the viewing angle adjustment layer 200 in the front direction and the side direction is described hereafter in detail with reference to FIG. 6.

FIG. 6 is a view showing polarization of light passing through the liquid crystal display of FIGS. 4 and 5, when voltage is being applied to the viewing angle adjustment layer 200.

As shown in FIG. 6, when the viewing angle adjustment layer 200 is seen from the front, that is, the viewing angle is 0 degrees, the left and right linear polarized light A passing through the transmissive axis 210t of the lower cutoff polarizing plate 210 perpendicularly passes through the liquid crystal capsule layer 250 and passes through a liquid crystal light axis of the liquid crystal molecules 253 in the liquid crystal capsule 251, such that the phase is not delayed while the light passes through the liquid crystal capsule 251. Therefore, the left and right linear polarized light A passing through the liquid crystal capsule layer 250, without a delay in phase, passes through the transmissive axis 230t of the upper cutoff polarizing plate 230 which is parallel to the transmissive axis 210t of the lower cutoff polarizing plate 210.

As described above, when the viewing angle is 0 degrees, the light passing through the liquid crystal display panel 100 passes through the viewing angle adjustment layer 200 without a change in the polarized state. Therefore, the liquid crystal display does not decrease in luminance in the front direction, even when a voltage is being applied to the viewing angle adjustment layer 200.

On the other hand, when the viewing angle adjustment layer 200 is seen from a side (for example, at viewing angles of 25 degrees and 50 degrees), left and right linear polarized light B1 (25 degrees) and B2 (50 degrees) passing through the transmissive axis 210t of the lower cutoff polarizing plate 210 passes through the liquid crystal capsule layer 250 at an angle and the phase is delayed by the liquid crystal molecules 253 arranged at angles in the liquid crystal capsule 251. Therefore, the left and right linear polarized light B1 and B2 change polarization and are blocked by the upper cutoff polarizing plate 230. As described above, when seen from the side, the light passing through the liquid crystal display panel 100 changes in the polarized state through the viewing angle adjustment layer 200, such that color shift occurs or luminance decreases.

In particular, in the example shown in FIG. 6, it can be seen that under a 240 nm phase delay of the liquid crystal capsule layer 250 due to the inclination of the liquid crystal molecules 253 in the liquid crystal capsule layer 250, when the viewing angle is 25 degrees, the left and right linear polarized light B1 is circular-polarized through the liquid crystal capsule layer 250 and only some of the left and right linear polarized light passes through the upper cutoff polarizing plate 230. Further, when the viewing angle is 50 degrees or more, the left and right linear polarized light B2 is linear-polarized vertically through the liquid crystal capsule layer 250 (that is, orthogonal to the transmissive axis 230t of the upper cutoff polarizing plate 230), such that all the left and right linear polarized light is blocked by the upper cutoff polarizing plate 230.

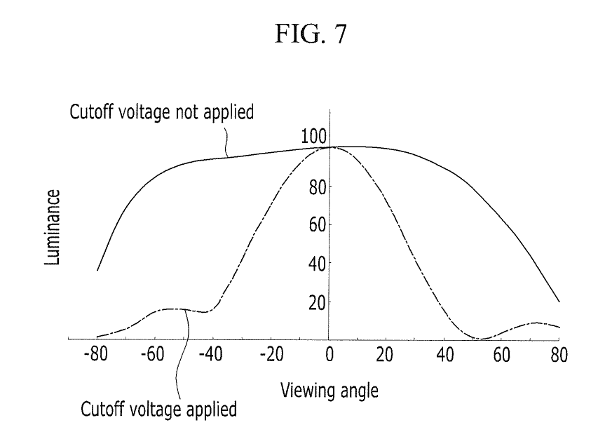

FIG. 7 is a graph showing luminance according to the viewing angle adjustment layer 200, when a cutoff voltage is being applied and not being applied to the viewing angle adjustment layer 200 of the liquid crystal display according to the first exemplary embodiment.

As shown in FIG. 7, when a cutoff voltage Vd is not being applied, 90% or more luminance is maintained at a viewing angle of 40 degrees. However, when the cutoff voltage Vd is being applied, the luminance of the liquid crystal display reduces by 80% or more at a viewing angle of 40 degrees. Accordingly, it can be seen that it is possible to simultaneously implement a wide viewing angle mode and a narrow viewing angle mode.

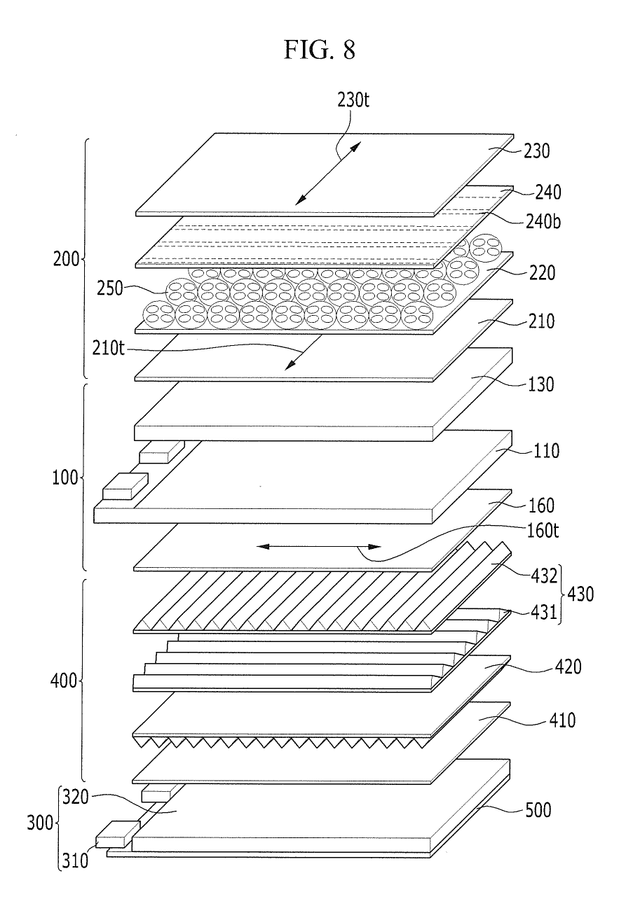

As described above, it is possible to manufacture the viewing angle adjustment layer 200 showing optimum viewing angle blocking characteristics by adjusting the cutoff voltage Vd applied to the liquid crystal capsule layer 250 such that the phase delay of the liquid crystal capsule layer 250 is adjusted when viewing from the side direction. Further, since the liquid crystal molecules 253 of the liquid crystal capsule layer 250 are arranged at angles that face each other with respect to the horizontal cut-off portions 240a, two domains are provided, such that gray inversion does not occur and visibility is improved. In addition, although the upper cutoff electrode 240 has a plurality of horizontal cut-off portions 240a that are parallel to the transmissive axis 210t of the lower cutoff polarizing plate 210 in the first exemplary embodiment, the upper cutoff electrode 240 may have a plurality of vertical cut-off portions 240b that are perpendicular to the transmissive axis 210t of the lower cutoff polarizing plate 210, as shown in FIG. 8.

Hereinafter, a liquid crystal display according to a second exemplary embodiment is described in detail with reference to FIG. 8.

FIG. 8 is an exploded perspective view illustrating when a cutoff voltage is being applied to a viewing angle adjustment layer 200 of a liquid crystal display. The second exemplary embodiment shown in FIG. 8 is substantially the same as the first exemplary embodiment shown in FIGS. 1 through 7 and described above, except for vertical cut-off portions 240b formed at the upper cutoff electrode 240. Accordingly, similar description will not be repeated.

As shown in FIG. 8, a transmissive axis 210t of a lower cutoff polarizing plate 210 and a transmissive axis 230t of an upper cutoff polarizing plate 230 are parallel to each other. Further, the upper cutoff electrode 240 has a plurality of vertical cut-off portions 240b that are perpendicular to the transmissive axis 210t of the lower cutoff polarizing plate 210.

When a cutoff voltage Vd is applied to the viewing angle adjustment layer 200, a vertical electric field is generated between the lower cutoff electrode 220 and the upper cutoff electrode 240. The vertical electric field bends around the vertical cut-off portions 240b of the upper cutoff electrode 240, such that liquid crystal molecules 253 in a liquid crystal capsule 251 are arranged at angles (for example, predetermined angles) to the horizontal surface of the upper cutoff electrode 240. The liquid crystal molecules 253 are arranged at angles to face each other with respect to the vertical cut-off portions 240b of the upper cutoff electrode 240.

When the viewing angle adjustment layer 200 is seen from the front, left and right linear polarized light A passing through the transmissive axis 210t of the lower cutoff polarizing plate 210 perpendicularly passes through the liquid crystal capsule layer 250 and passes through the liquid crystal light axis of the liquid crystal molecules 253 in the liquid crystal capsule 251, such that the phase is not delayed through the liquid crystal capsule 251. Therefore, the left and right linear polarized light A passing through the liquid crystal capsule layer 250 without a phase delay passes through the transmissive axis 230t of the upper cutoff polarizing plate 230, which is parallel to the transmissive axis 210t of the lower cutoff polarizing plate 210.

On the other hand, when the viewing angle adjustment layer 200 is seen from a side, the left and right linear polarized light B1 and B2 passing through the transmissive axis 210t of the lower cutoff polarizing plate 210 passes through the liquid crystal capsule layer 250 at an angle and the phase is delayed by the liquid crystal molecules 253 arranged at angles in the liquid crystal capsule 251. Therefore, the left and right linear polarized light B1 and B2 change in the polarized state and are blocked by the upper cutoff polarizing plate 230.

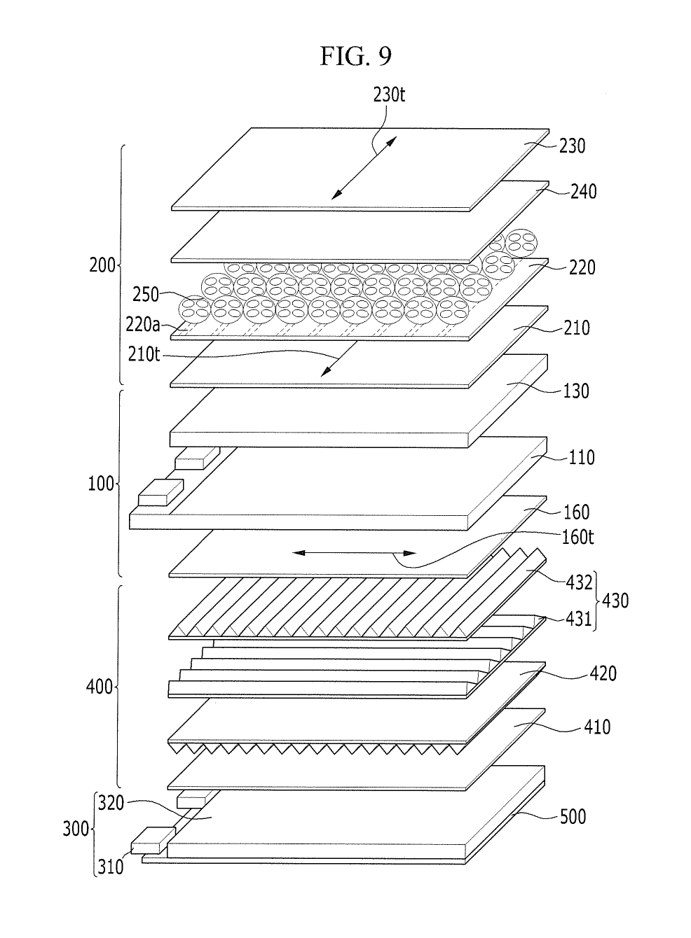

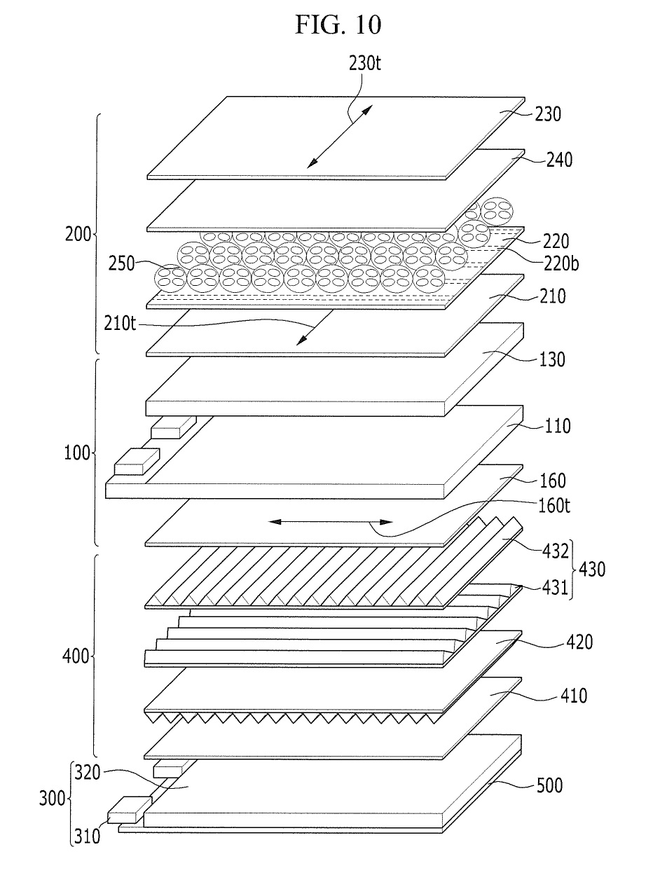

The horizontal cut-off portions 240a and the vertical cut-off portions 240b are formed at the upper cutoff electrode 240 in the first exemplary embodiment and the second exemplary embodiment, respectively. In other embodiments according to the present invention, horizontal cut-off portions 220a or vertical cut-off portions 220b are formed at the lower cutoff electrode 220, as shown in FIGS. 9 and 10.

FIG. 9 is an exploded perspective view illustrating when a cutoff voltage is being applied to a viewing angle adjustment layer 200 of a liquid crystal display according to a third exemplary embodiment. FIG. 10 is an exploded perspective view illustrating when a cutoff voltage is being applied to a viewing angle adjustment layer 200 of a liquid crystal display according to a fourth exemplary embodiment.

As shown in FIG. 9, in the liquid crystal display, a transmissive axis 210t of a lower cutoff polarizing plate 210 and a transmissive axis 230t of an upper cutoff polarizing plate 230 are parallel to each other. Further, the lower cutoff electrode 220 has a plurality of horizontal cut-off portions 220a parallel to the transmissive axis 210t of the lower cutoff polarizing plate 210. The operation and effect are the same as those in the first exemplary embodiment shown in FIGS. 1 through 7 and described above.

As shown in FIG. 10, in the liquid crystal display, a transmissive axis 210t of a lower cutoff polarizing plate 210 and a transmissive axis 230t of an upper cutoff polarizing plate 230 are parallel to each other. Further, the lower cutoff electrode 220 has a plurality of vertical cut-off portions 220b perpendicular to the transmissive axis 210t of the lower cutoff polarizing plate 210. The operation and effect are the same as those in the second exemplary embodiment shown in FIG. 8 and described above.

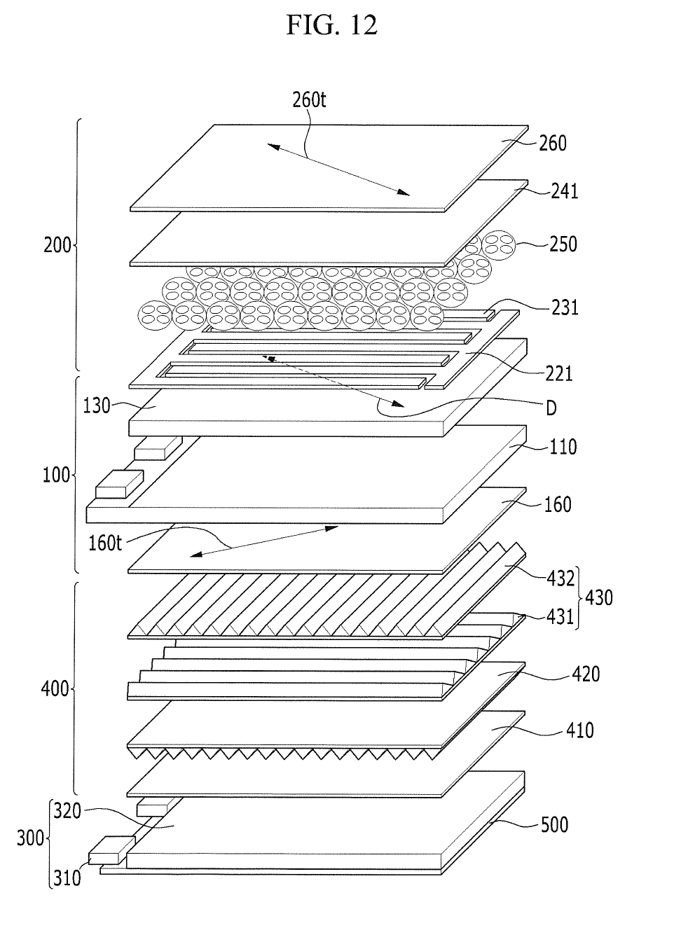

Although the vertical electric field is generated in the viewing angle adjustment layer 200 in the first exemplary embodiment, a horizontal electric field may be formed in the viewing angle adjustment layer 200, as shown in FIGS. 11 and 12.

Hereinafter, a liquid crystal display according to a fifth exemplary embodiment is described in detail with reference to FIGS. 11 and 12.

FIG. 11 is an exploded perspective view illustrating when a cutoff voltage is not being applied to a viewing angle adjustment layer 200 of a liquid crystal display. FIG. 12 is an exploded perspective view illustrating when a cutoff voltage is being applied to the viewing angle adjustment layer 200 of the liquid crystal display.

The fifth exemplary embodiment shown in FIGS. 11 and 12 is substantially the same as the first exemplary embodiment shown in FIGS. 1 through 7 and described above, except that the horizontal electric field is formed. Accordingly, similar description is not repeated.

As shown in FIGS. 11 and 12, a viewing angle adjustment layer 200 includes a common cutoff electrode 221 formed on a liquid crystal display panel 100, a pixel cutoff electrode 231 formed on the liquid crystal display panel 100 and parallel to the common cutoff electrode 221, an upper cutoff substrate 241 having an inner side facing the liquid crystal display panel 100, and a liquid crystal capsule layer 250 located between the common cutoff electrode 221, the pixel cutoff electrode 231, and the upper cutoff substrate 241. The common cutoff electrode 221 is shown in FIGS. 11 and 12 with a long side together with a plurality of extensions perpendicular to the long side. Similarly, pixel cutoff electrode 231 is shown with a long side together with a plurality of extensions perpendicular to the long side. The long sides of the common cutoff electrode 221 and the pixel cutoff electrode 231 are parallel to each other, and the extensions of the common cutoff electrode 221 correspond to and are parallel to the extensions of the pixel cutoff electrode 231.

A lower display polarizing plate 160 is attached to the bottom of the liquid crystal display panel 100 and an upper display polarizing plate 260 is attached to an outer side of the upper cutoff substrate 241. A transmissive axis 160t of the lower display polarizing plate 160 and a transmissive axis 260t of the upper display polarizing plate 260 are perpendicular to each other. Further, the long side of the common cutoff electrode 221 and the transmissive axis 160t of the lower display polarizing plate 160 make an angle of 45 degrees±10 degrees (that is, between 35 degrees and 55 degrees).

In this case, when a cutoff voltage Vd is applied to the viewing angle adjustment layer 200, a horizontal electric field parallel to the surface of the liquid crystal display panel 100 is formed between the common cutoff electrode 221 and the pixel cutoff electrode 231. Liquid crystal molecules 253 in the liquid crystal capsule 251 have positive dielectric anisotropy, such that they are parallel to the horizontal electric field. That is, the liquid crystal molecules 253 are aligned perpendicular to the long side of the common cutoff electrode 221.

When the viewing angle adjustment layer 200 is seen from the front, linear polarized light C passing through the liquid crystal display panel 100 perpendicularly passes through the liquid crystal capsule layer 250 and passes through the liquid crystal light axis of the liquid crystal molecules 253 in the liquid crystal capsule 251, such that the phase is not delayed through the liquid crystal capsule 251. As described above, the linear polarized light C passing through the liquid crystal display panel 100 passes through the viewing angle adjustment layer 200 without a change in the polarized state. Therefore, the liquid crystal display according to the fifth exemplary embodiment does not reduce in luminance in the front direction, even when a voltage is being applied to the viewing angle adjustment layer 200.

On the other hand, when the viewing angle adjustment layer 200 is seen from a side, linear polarized light D passing through the liquid crystal display panel 100 passes through the liquid crystal capsule layer 250 at an angle and the phase is delayed by the angle of 45 degrees±10 degrees between the liquid crystal molecules 253 aligned perpendicular to the transmissive axis of the lower display polarizing plate 160 and the long side of the common cutoff electrode 221. As described above, when seen from the side, the linear polarized light D passing through the liquid crystal display panel 100 changes in the polarized state through the viewing angle adjustment layer 200 and some of the light is blocked by the upper display polarizing plate 260, such that color shift occurs or luminance reduces.

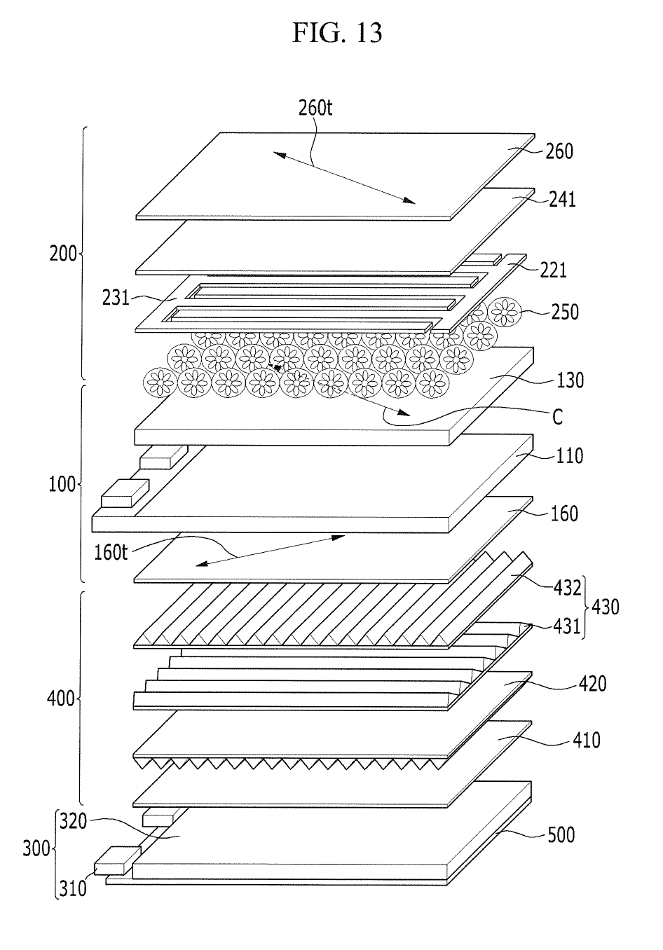

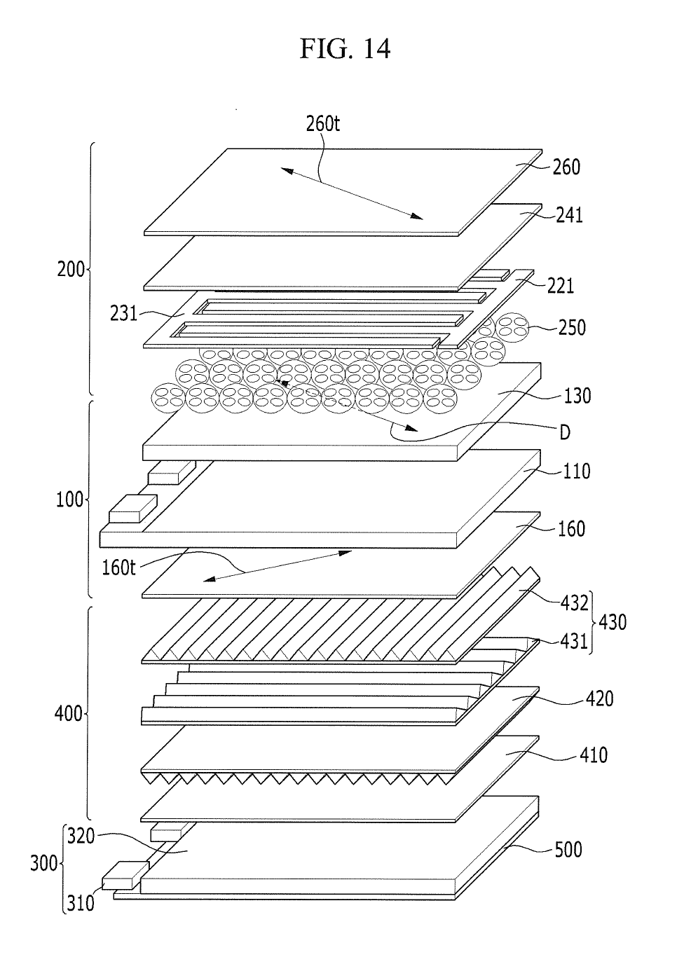

Although the common cutoff electrode 221 and the pixel cutoff electrode 231 are formed on the liquid crystal display panel 100 in the fifth exemplary embodiment, the common cutoff electrode 221 and the pixel cutoff electrode 231 may be formed on the upper cutoff substrate 241, as shown in FIGS. 13 and 14.

Hereinafter, a liquid crystal display according to a sixth exemplary embodiment is described in detail with reference to FIGS. 13 and 14.

FIG. 13 is an exploded perspective view illustrating when a cutoff voltage is not being applied to a viewing angle adjustment layer 200 of a liquid crystal display. FIG. 14 is an exploded perspective view illustrating when a cutoff voltage is being applied to the viewing angle adjustment layer 200 of the liquid crystal display.

The sixth exemplary embodiment shown in FIGS. 13 and 14 is substantially the same as the fifth exemplary embodiment shown in FIGS. 11 and 12 and described above, except that the common cutoff electrode 221 and the pixel cutoff electrode 231 are formed on the upper cutoff substrate, such that similar description is not repeated.

As shown in FIG. 13 and FIG. 14, a viewing angle adjustment layer 200 includes an upper cutoff substrate 241 having an inner side facing a liquid crystal display panel 100, a common cutoff electrode 221 formed on the upper cutoff substrate 241, a pixel cutoff electrode 231 formed on the upper cutoff substrate 241 and parallel to the common cutoff electrode 221, and a liquid crystal capsule layer 250 located between the liquid crystal display panel 100, the common cutoff electrode 221, and the pixel cutoff electrode 231.

A lower display polarizing plate 160 is attached to the bottom of the liquid crystal display panel 100 and an upper display polarizing plate 260 is attached to an outer side of the upper cutoff substrate 241. A transmissive axis 160t of the lower display polarizing plate 160 and a transmissive axis 260t of the upper display polarizing plate 260 are perpendicular to each other. Further, the long side of the common cutoff electrode 221 and the transmissive axis 160t of the lower display polarizing plate 160 make an angle of 45 degrees±10 degrees (that is, an angle between 35 degrees and 55 degrees).

In this case, when a cutoff voltage Vd is applied to the viewing angle adjustment layer 200, a horizontal electric field parallel to the surface of the liquid crystal display panel 100 is formed between the common cutoff electrode 221 and the pixel cutoff electrode 231. Since liquid crystal molecules 253 in the liquid crystal capsule 251 have positive dielectric anisotropy, they are parallel to the horizontal electric field. That is, the liquid crystal molecules 253 are aligned perpendicular to the long side of the common cutoff electrode 221.

When the viewing angle adjustment layer 200 is seen from the front, linear polarized light C passing through the liquid crystal display panel 100 perpendicularly passes through the liquid crystal capsule layer 250 and passes through the liquid crystal light axis of the liquid crystal molecules 253 in the liquid crystal capsule 251, such that the phase is not delayed through the liquid crystal capsule 251. As described above, the linear polarized light C passing through the liquid crystal display panel 100 passes through the viewing angle adjustment layer 200 without a change in the polarized state. Therefore, the liquid crystal display according to the sixth exemplary embodiment does not decreases in luminance in the front direction, even when a voltage is being applied to the viewing angle adjustment layer 200.

On the other hand, when the viewing angle adjustment layer 200 is seen from a side, linear polarized light D passing through the liquid crystal display panel 100 passes through the liquid crystal capsule layer 250 at an angle and the phase is delayed by the angle of 45 degrees±10 degrees between the liquid crystal molecules 253 aligned perpendicular to the long side of the common cutoff electrode 221 and the transmissive axis 160t of the lower display polarizing plate 160. As described above, when seen from the side, the linear polarized light D passing through the liquid crystal display panel 100 changes in the polarized state through the viewing angle adjustment layer 200 and some of the light is blocked by the upper display polarizing plate 260, such that color shift occurs or luminance reduces.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and equivalents thereof.

### DESCRIPTION OF SELECTED SYMBOLS

100: Liquid crystal display panel
200: Viewing angle adjustment layer
210: Lower cutoff polarizing plate
220: Lower cutoff electrode
230: Upper cutoff polarizing plate
240: Upper cutoff electrode
250: Liquid crystal capsule layer
251: Liquid crystal capsule
253: Liquid crystal molecules

What is claimed is:

1. A liquid crystal display comprising:
a liquid crystal display panel for displaying an image; and
a viewing angle adjustment layer on the liquid crystal display panel, the viewing angle adjustment layer comprising:
a lower cutoff polarizing plate;
a lower cutoff electrode on the lower cutoff polarizing plate;
an upper cutoff polarizing plate facing the lower cutoff polarizing plate;
an upper cutoff electrode on the upper cutoff polarizing plate; and
a liquid crystal capsule layer between the lower cutoff electrode and the upper cutoff electrode, and comprising a plurality of liquid crystal capsules,
wherein a diameter of the liquid crystal capsules is between 50 nm and a shortest wavelength of visible light.

2. The liquid crystal display of claim 1, wherein a transmissive axis of the lower cutoff polarizing plate and a transmissive axis of the upper cutoff polarizing plate are parallel to each other.

3. The liquid crystal display of claim 1, wherein the upper cutoff electrode has a plurality of horizontal cut-off portions parallel to a transmissive axis of the lower cutoff polarizing plate.

4. The liquid crystal display of claim 1, wherein the upper cutoff electrode has a plurality of vertical cut-off portions perpendicular to a transmissive axis of the lower cutoff polarizing plate.

5. The liquid crystal display of claim 1, wherein the lower cutoff electrode has a plurality of horizontal cut-off portions parallel to a transmissive axis of the lower cutoff polarizing plate.

6. The liquid crystal display of claim 1, wherein the lower cutoff electrode has a plurality of vertical cut-off portions perpendicular to a transmissive axis of the lower cutoff polarizing plate.

7. A liquid crystal display comprising:
a liquid crystal display panel for displaying an image; and
a viewing angle adjustment layer on the liquid crystal display panel, the viewing angle adjustment layer comprising:
a common cutoff electrode on the liquid crystal display panel;
a pixel cutoff electrode on the liquid crystal display panel and parallel to the common cutoff electrode;
an upper cutoff substrate having an inner side facing the liquid crystal display panel; and
a liquid crystal capsule layer between the common cutoff electrode, the pixel cutoff electrode, and the upper cutoff substrate, and comprising a plurality of liquid crystal capsules,
wherein a diameter of the liquid crystal capsules is between 50 nm and a shortest wavelength of visible light.

8. The liquid crystal display of claim 7, further comprising:
a lower display polarizing plate at a bottom of the liquid crystal display panel; and
an upper display polarizing plate at an outer side of the upper cutoff substrate.

9. The liquid crystal display of claim 8, wherein the common cutoff electrode has a long side that makes an angle with a transmissive axis of the lower display polarizing plate of 45 degrees±10 degrees.

10. A liquid crystal display comprising:
a liquid crystal display panel for displaying an image; and
a viewing angle adjustment layer on the liquid crystal display panel, the viewing angle adjustment layer comprising:
an upper cutoff substrate having an inner side facing the liquid crystal display panel;
a common cutoff electrode on the upper cutoff substrate;
a pixel cutoff electrode on the upper cutoff substrate and parallel to the common cutoff electrode; and
a liquid crystal capsule layer between the liquid crystal display panel, the common cutoff electrode, and the pixel cutoff electrode, and comprising a plurality of liquid crystal capsules,
wherein a diameter of the liquid crystal capsules is between 50 nm and a shortest wavelength of visible light.

11. The liquid crystal display of claim 10, further comprising:
a lower display polarizing plate at a bottom of the liquid crystal display panel; and
an upper display polarizing plate at an outer side of the upper cutoff substrate.

12. The liquid crystal display of claim 11, wherein the common cutoff electrode has a long side that makes an angle with a transmissive axis of the lower display polarizing plate of 45 degrees±10 degrees.
